(19) United States
(12) Patent Application Publication
(10) Pub. No.: US 2026/0246358 A1
(43) Pub. Date: Aug. 20, 2026

(54) POWER CONVERSION APPARATUS AND ENERGY STORAGE SYSTEM

(71) Applicant: Huawei Digital Power Technologies Co., Ltd., Shenzhen (CN)

(72) Inventors: Baoguo CHEN, Dongguan (CN); Ren SHENG, Dongguan (CN); Rui GE, Dongguan (CN); Ling LIU, Shenzhen (CN)

(73) Assignee: Huawei Digital Power Technologies Co., Ltd., Shenzhen (CN)

(21) Appl. No.: 19/644,033

(22) Filed: Apr. 10, 2026

Related U.S. Application Data
(62) Division of application No. 18/466,077, filed on Sep. 13, 2023.

(30) Foreign Application Priority Data
Sep. 13, 2022 (CN) 202211111958.9

(51) Int. Cl. H02M 1/00; H02M 3/158

(52) U.S. Cl. CPC H02M 1/0048; H02M 3/158

(57) ABSTRACT

This application provides a power conversion apparatus and an energy storage system, including a power conversion circuit, a first power terminal, a second power terminal, and a third power terminal. The power conversion circuit includes a first positive end, a first negative end, a second positive end, a second negative end, and at least one power device. The first negative end and the second negative end have a same potential. The power conversion circuit is configured to convert a first voltage input by a first device into a second voltage and output the second voltage to a second device. The first power terminal is connected to the first positive end, the first negative end or the second negative end is connected to the second power terminal, and the third power terminal is connected to the second positive end.

### CROSS-REFERENCE TO RELATED APPLICATION

This application is a continuation of U.S. patent application Ser. No. 18/466,077, filed on Sep. 13, 2023, which claims priority to Chinese Patent Application No. 202211111958.9, filed on Sep. 13, 2022. All of the aforementioned patent applications are hereby incorporated by reference in their entireties.

### TECHNICAL FIELD

The embodiments relate to a power electronics system, a power conversion apparatus, and an energy storage system.

### BACKGROUND

At present, a new energy power generation technology has made great progress. To maintain stability of a new energy power generation system, an energy storage system with a capacity may be required. As a proportion of new energy generation is increasing, an energy storage system with a gradually increasing capacity needs to be configured. Therefore, it is important to improve reliability and system efficiency of the energy storage system.

Currently, most energy storage systems use four-port non-isolated direct current to direct current (DC-DC) topology to implement a charge-discharge function and a buck-boost function of a battery in the energy storage system. During charging and discharging, all power currents are carried by a printed circuit board (PCB). When a load power is larger, the more serious the PCB heats, which causes more loss.

In view of this, a power conversion apparatus may ensure the power current flows through the PCB board as little as possible, to reduce heating and a loss of the PCB caused by the flowing current and improve system efficiency and reliability.

### SUMMARY

The embodiments may provide a power conversion apparatus and an energy storage system, so that a power current may flow through a PCB as little as possible, to reduce heating and a loss of the PCB caused by the flowing current and improve system efficiency and reliability.

According to a first aspect, the embodiments may provide a power conversion apparatus, including a power conversion circuit, a first power terminal, a second power terminal, and a third power terminal. The power conversion circuit includes a first positive end, a first negative end, a second positive end, a second negative end, and at least one power device. The first negative end and the second negative end have a same potential. The power conversion circuit is configured to convert a first voltage input by a first device into a second voltage and output the second voltage to a second device. The first power terminal is connected to the first positive end, the first negative end and/or the second negative end is connected to the second power terminal, and the third power terminal is connected to the second positive end.

According to the power conversion apparatus, a three-power terminal structure is used, so that a power current may flow through an external power bus, and power currents that flow through a bus connected to the first negative end or the second negative end may mutually cancel each other out, which reduces a loss on a PCB board caused by the flowing current and improves system efficiency and reliability.

In a possible embodiment, the second power terminal may include a first sub-terminal and a second sub-terminal. The first sub-terminal is connected to a first negative output end of the first device, and the second sub-terminal is connected to a second negative input end of the second device.

In a possible embodiment, a first positive output end of the first device is connected to the first power terminal, and a first negative output end of the first device is connected to the second power terminal. A second positive input end of the second device is connected to the third power terminal, and a second negative input end of the second device is connected to the second power terminal. The first device is separately connected to the first power terminal and the second power terminal through the first positive output end and the first negative output end, to input a first voltage to the power conversion circuit. The second device is separately connected to the third power terminal and the second power terminal through the second positive input end and the second negative input end, to receive a second voltage output by the power conversion circuit. In this topology structure, the first negative end and the second negative end in the power conversion circuit are used when commonly grounded, and power currents flowing through the bus connected to the first negative end or the second negative end may mutually cancel each other out, which reduces the loss caused by the flowing current.

In a possible embodiment, the first positive output end of the first device is connected to the second power terminal, the first negative output end of the first device is connected to the first power terminal, a second positive input end of the second device is connected to the second power terminal, and a second negative input end of the second device is connected to the third power terminal.

The first device is separately connected to the second power terminal and the first power terminal through the first positive output end and the first negative output end, to input the first voltage to the power conversion circuit. The second device is separately connected to the second power terminal and the third power terminal through the second positive input end and the second negative input end, to receive the second voltage output by the power conversion circuit. In this topology structure, the first positive end and the second positive end in the power conversion circuit are used when sharing a power supply, and power currents flowing through the bus connected to the first negative end or the second negative end may mutually cancel each other out, which reduces the loss caused by the flowing current.

In a possible embodiment, the power conversion circuit may include a first capacitor, a first switch component, a second switch component, a first inductor, and a second capacitor, where a first end of the first capacitor is connected to a first end of the first switch component, a second end of the first switch component is separately connected to a first end of the first inductor and a first end of the second switch component, a third end of the first switch component is configured to input a signal for controlling a status of the first switch component, a second end of the second switch component is separately connected to a second end of the first capacitor and a first end of the second capacitor, a third end of the second switch component is configured to input a signal for controlling a status of the second switch component, and a second end of the first inductor is connected to a second end of the second capacitor. The first positive end is connected to the first end of the first capacitor, the first negative end is connected to the second end of the first capacitor, the second positive end is connected to the first end of the second capacitor, and the second negative end is connected to the second end of the second capacitor; or the first positive end is connected to the first end of the second capacitor, the first negative end is connected to the second end of the second capacitor, the second positive end is connected to the first end of the first capacitor, and the second negative end is connected to the second end of the first capacitor.

When the power conversion circuit meets a condition of being enabled, turn-off of the power device in the power conversion circuit is controlled to change according to a rule, so that an output voltage of the power conversion circuit may be adjusted. To be not limited to a buck mode, a boost mode, or the like, when the first positive end is connected to the first end of the first capacitor and the first negative end is connected to the second end of the first capacitor, the second positive end is connected to the first end of the second capacitor, and the second negative end is connected to the second end of the second capacitor. In this case, the power conversion circuit is in a buck mode in a forward direction. When the first positive end is connected to the first end of the second capacitor, and the first negative end is connected to the second end of the second capacitor, the second positive end is connected to the first end of the first capacitor, and the second negative end is connected to the second end of the first capacitor. In this case, the power conversion circuit is in a boost mode in a reverse direction.

In a possible embodiment, the power conversion circuit may include a third capacitor, a second inductor, a third switch component, a fourth switch component, and a fourth capacitor, where a first end of the third capacitor is connected to a first end of the second inductor, a second end of the second inductor is separately connected to a first end of the third switch component and a first end of the fourth switch component, a second end of the third capacitor is separately connected to a second end of the third switch component and a second end of the fourth capacitor, a second end of the fourth switch component is connected to a first end of the fourth capacitor, a third end of the third switch component is configured to input a signal for controlling a status of the third switch component, and a third end of the fourth switch component is configured to input a signal for controlling a status of the fourth switch component. The first positive end is connected to the first end of the third capacitor, the first negative end is connected to the second end of the third capacitor, the second positive end is connected to the first end of the fourth capacitor, and the second negative end is connected to the second end of the fourth capacitor; or the first positive end is connected to the first end of the fourth capacitor, the first negative end is connected to the second end of the fourth capacitor, the second positive end is connected to the first end of the third capacitor, and the second negative end is connected to the second end of the third capacitor.

When the power conversion circuit meets a condition of being enabled, turn-off of the power device in the power conversion circuit is controlled to change according to a rule, so that an output voltage of the power conversion circuit may be adjusted. To be not limited to a buck mode, a boost mode, or the like, when the first positive end is connected to the first end of the third capacitor, and the first negative end is connected to the second end of the third capacitor, the second positive end is connected to the first end of the fourth capacitor, and the second negative end is connected to the second end of the fourth capacitor. In this case, the power conversion circuit is in a boost mode in a forward direction. When the first positive end is connected to the first end of the fourth capacitor, and the first negative end is connected to the second end of the fourth capacitor, the second positive end is connected to the first end of the third capacitor, and the second negative end is connected to the second end of the third capacitor. In this case, the power conversion circuit is in a buck mode in a reverse direction.

In a possible embodiment, the power conversion circuit may include a fifth capacitor, a third inductor, a fifth switch component, a sixth switch component, a seventh switch component, an eighth switch component, and a sixth capacitor. A first end of the fifth capacitor is connected to a first end of the fifth switch component, a second end of the fifth switch component is connected to the first end of the third inductor, the second end of the fifth switch component is connected to a first end of the sixth switch component, a second end of the sixth switch component is connected to a second end of the fifth capacitor, a first end of the seventh switch component is connected to a first end of the sixth capacitor, a second end of the seventh switch component is connected to a first end of the eighth switch component, a second end of the eighth switch component is connected to the second end of the sixth switch component, the second end of the eighth switch component is further connected to a second end of the sixth capacitor, a second end of the third inductor is connected to the first end of the seventh switch component, a third end of the fifth switch component is configured to input a signal for controlling a status of the fifth switch component, a third end of the sixth switch component is configured to input a signal for controlling a status of the sixth switch component, a third end of the seventh switch component is configured to input a signal for controlling a status of the seventh switch component, and a third end of the eighth switch component is configured to input a signal for controlling a status of the eighth switch component. The first positive end is connected to the first end of the fifth capacitor, the first negative end is connected to the second end of the fifth capacitor, the second positive end is connected to the first end of the sixth capacitor, and the second negative end is connected to the second end of the sixth capacitor; or the first positive end is connected to the first end of the sixth capacitor, the first negative end is connected to the second end of the sixth capacitor, the second positive end is connected to the first end of the fifth capacitor, and the second negative end is connected to the second end of the fifth capacitor.

To suppress common-mode noise of the power conversion circuit, in a possible embodiment, the power conversion apparatus further includes a three-wire common-mode inductor. The three-wire common-mode inductor includes a first winding, a second winding, and a third winding. A dotted terminal of the first winding is connected to the first power terminal, a dotted terminal of the second winding is connected to a second power terminal, and a dotted terminal of the third winding is connected to a third power terminal. An undotted terminal of the first winding is connected to the first positive end, the first negative end and/or the second negative end is connected to an undotted terminal of the second winding, and an undotted terminal of the third winding is connected to the second positive end.

In a possible embodiment, the power conversion apparatus further includes a controller, configured to control turn-off of the power device in the power conversion circuit, to adjust the output voltage of the power conversion circuit.

In a possible embodiment, the second power terminal is a copper bar or a connector structure. The first negative output end of the first device and the second negative input end of the second device may be connected to the first negative end or the second negative end by using a cable copper bar or a connector structure. Alternatively, the first positive output end of the first device and the second positive input end of the second device may be connected to the first positive end or the second positive end by using a copper bar or a connector structure.

In a possible embodiment, at least one of the following devices may be included between the first power terminal and the second power terminal: a fuse, a switch component, or a shunt. The fuse may be blown immediately when a current in a loop increases rapidly because of a short-circuit fault of a line, so as to protect an electrical device and a line connected to the fuse, thereby avoiding an accident caused by damage. The switch component is configured to control a connection status between the first power terminal and the second power terminal. The shunt is configured to measure a magnitude of a current between the first power terminal and the second power terminal, and is made according to a principle a voltage is generated at two ends of a resistor when the current passes through the resistor.

According to a second aspect, the embodiments may provide an energy storage system, including a battery pack and the power conversion apparatus according to the first aspect. The battery pack includes a plurality of battery cells connected in series, and the power conversion apparatus is connected to the battery pack, configured to convert a direct current input to the battery pack, and/or convert a direct current output from the battery pack.

According to a third aspect, the embodiments may provide an optical storage system, including an inverter, the power conversion apparatus according to the first aspect, and a battery pack. The power conversion apparatus is configured to convert a current from the inverter, and input the converted current to the battery pack, and/or is configured to convert a current of the battery pack, and output the converted current to a power grid or a load.

For the second aspect or the third aspect, refer to descriptions of the first aspect. No repeated description is provided.

### BRIEF DESCRIPTION OF THE DRAWINGS

FIG. 1 is a schematic diagram of a four-port non-isolated DC-DC topology;

FIG. 2A is a schematic diagram 1 of a structure of a power conversion apparatus;

FIG. 2B is a schematic diagram 2 of a structure of a power conversion apparatus;

FIG. 3A is a schematic diagram of a current flow direction of an existing power conversion circuit;

FIG. 3B is a schematic diagram 1 of a current flow direction of a power conversion apparatus;

FIG. 3C is a schematic diagram 2 of a current flow direction of a power conversion apparatus;

FIG. 4 is a schematic diagram 1 of a connection of a power conversion apparatus;

FIG. 5 is a schematic diagram 2 of a connection of a power conversion apparatus;

FIG. 6 is a schematic diagram 1 of a structure of a power conversion circuit;

FIG. 7 is a schematic diagram 2 of a structure of a power conversion circuit;

FIG. 8 is a schematic diagram 3 of a structure of a power conversion circuit; and

FIG. 9 is a schematic diagram 3 of a structure of a power conversion apparatus.

### DETAILED DESCRIPTION OF THE EMBODIMENTS

To make objectives, solutions, and advantages clearer, the following further describes the embodiments in detail with reference to the accompanying drawings. However, example embodiments may be implemented in a plurality of forms and should not be construed as being limited to embodiments described herein. On the contrary, these embodiments may be more comprehensive and complete and may fully convey the concept of the example embodiments to a person skilled in the art. Identical reference numerals in the accompanying drawings denote identical or similar structures. Therefore, repeated description thereof is omitted. Expressions of positions and directions are described by using the accompanying drawings as an example. However, changes may also be made as required, and all the changes fall within the scope of the embodiments. The accompanying drawings are merely used to illustrate relative position relationships and do not represent an actual scale.

To make objectives, solutions, and advantages clearer, the following further describes the embodiments in detail with reference to the accompanying drawings. An operation method in a method embodiment may also be applied to an apparatus embodiment or a system embodiment. It should be noted that “at least one” means one or more, and “a plurality of” means two or more. In view of this, in embodiments, “a plurality of” may also be understood as “at least two”. The term “and/or” describes an association relationship for describing associated objects and represents that three relationships may exist. For example, A and/or B may represent the following three cases: only A exists, both A and B exist, and only B exists. In addition, the character “/” generally indicates an “or” relationship between the associated objects unless otherwise specified. In addition, it should be understood that in the description, terms such as “first” and “second” are merely used for distinction and description and shall not be understood as an indication or implication of relative importance or an indication or implication of an order.

It should be noted that a “connection” in the embodiments refers to an electric connection, and a connection between two electrical elements may be a direct or indirect connection between the two electrical elements. For example, a connection between A and B may represent that A and B are directly connected to each other, or A and B are indirectly connected to each other by using one or more other electrical elements. For example, the connection between A and B may also represent that A is directly connected to C, C is directly connected to B, and A and B are connected to each other through C.

The following first describes an application scenario in the embodiments.

In recent years, new energy power stations, such as wind and solar power stations, generate more and more energy. Because the new energy power stations are characterized by unstable power generation, an impact on a power grid will deteriorate frequency stability of the power grid. To maintain a stable frequency of a power system, an energy storage system with a capacity may be required. The energy storage system may store electric energy by using a medium and release the stored energy to generate electricity when necessary. As a proportion of new energy generation increases, a capacity of the energy storage system also increases. Therefore, reliability and system efficiency of the energy storage system needs to be improved.

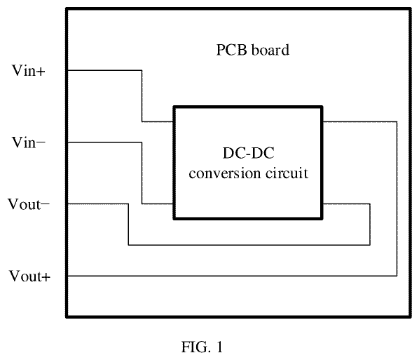

A power conversion circuit in an energy storage system may use a four-port non-isolated DC-DC topology structure, to implement a charge-discharge function and a buck-boost function of a battery in the energy storage system. FIG. 1 is a schematic diagram of a four-port non-isolated DC-DC topology. One end of the four-port (Vin+, Vin−, Vout+, and Vout−) non-isolated DC-DC topology structure may be connected to an energy storage unit, and another end may be connected to an inverter, so that the inverter converts DC power into AC power and outputs the AC power to the power grid or load. It can be seen from FIG. 1 that, all power currents (power input, power output, and a power ground cable) are carried by a PCB board. With rapid increase of component density and power, the PCB board heats more and more seriously, and a caused loss is also increasing.

In view of this, the embodiments may provide a power conversion apparatus, so that power currents flowing through a bus connected to a first negative end or a second negative end may mutually cancel each other out, so that a part of the power currents does not flow through a PCB board, which reduces a loss on the PCB board caused by the flowing current, and improves system efficiency and reliability.

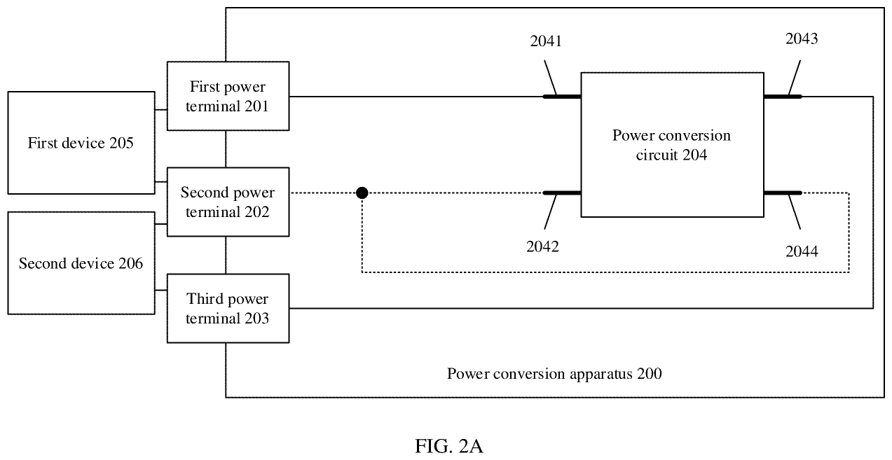

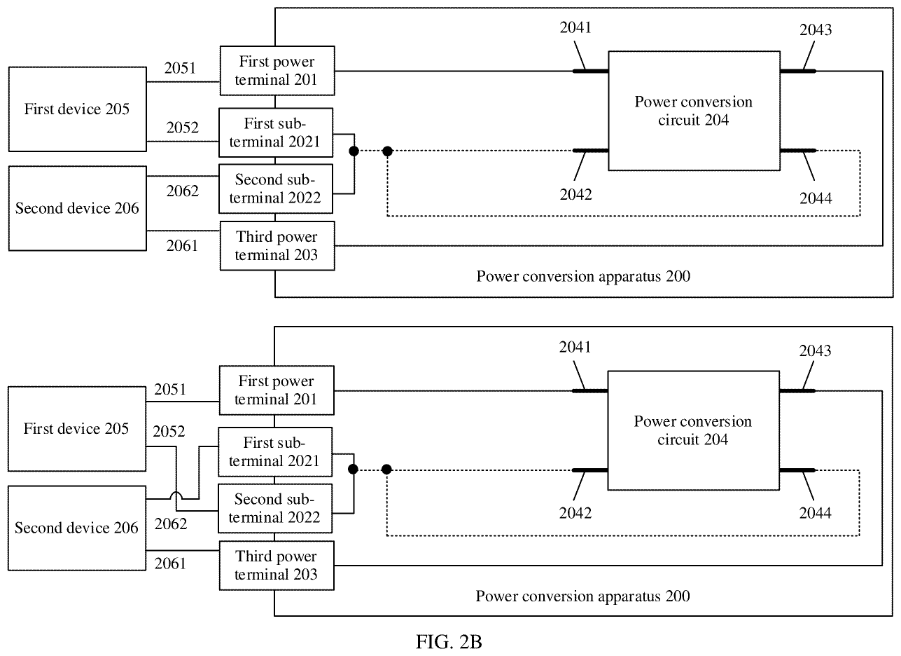

FIG. 2A is a schematic diagram 1 of a structure of a power conversion apparatus. A power conversion apparatus 200 includes a first power terminal 201, a second power terminal 202, a third power terminal 203, and a power conversion circuit 204. The power conversion circuit 204 includes a first positive end 2041, a first negative end 2042, a second positive end 2043, a second negative end 2044, and at least one power device. The first negative end 2042 and the second negative end 2044 have a same potential. The power conversion circuit 204 is configured to convert a first voltage input by the first device 205 into a second voltage and output the second voltage to the second device 206. The first power terminal 201 is connected to the first positive end 2041, the first negative end 2042 and/or the second negative end 2044 is connected to the second power terminal 202, and the third power terminal 203 is connected to the second positive end 2043.

The power conversion circuit 204 may be a conversion circuit that converts a direct current with a constant voltage into a direct current with an adjustable voltage, and may also be referred to as a direct current chopper. An output voltage may be regulated by changing turn-on and turn-off of the at least one power device in the power conversion circuit 204, or changing a ratio of duration in which a switch component is on or off. For example, the power conversion circuit 204 may be a buck circuit, a boost circuit, a buck-boost circuit, or the like. A circuit type and a circuit combination manner should be known by a person skilled in the art, and details are not described herein.

The power device may be one or more of a plurality of types of switch components, for example, a relay, a metal oxide semiconductor field effect transistor (MOSFET), a bipolar junction transistor (BJT), an insulated gate bipolar transistor (IGBT), or a silicon carbide (SiC) power transistor. Details are not listed in this embodiment.

The power conversion circuit 204 is configured to convert the first voltage input by the first device 205 into the second voltage, and output the second voltage to the second device 206. The first device 205 may be an energy storage unit, and the second device 206 may be a load device or a power grid. An energy storage component of the energy storage unit supplies power to the load device when energy generation of a new energy power station is unstable. Because a voltage provided by the energy storage component cannot meet a voltage requirement of the load device, the energy storage unit may perform voltage regulation by using the power conversion circuit 204, to supply power to the load device.

For example, if the first voltage is greater than the second voltage, the power conversion circuit 204 may be the buck circuit. If the first voltage is less than the second voltage, the power conversion circuit 204 may be the boost circuit. If a value relationship between the first voltage and the second voltage is difficult to be determined in advance, the power conversion circuit 204 may be the buck-boost circuit or the like.

FIG. 2B is a schematic diagram 2 of a structure of the power conversion apparatus. The second power terminal 202 may include a first sub-terminal 2021 and a second sub-terminal 2022, where the first sub-terminal 2021 is connected to a first negative output end 2052 of the first device 205, and the second sub-terminal 2022 is connected to a second negative input end 2062 of the second device 206.

The second power terminal may further have two external connection ports, to facilitate connection between the first device 205 and the second device 206. During an actual connection, a person skilled in the art may connect the first negative output end 2052 of the first device 205 to the first sub-terminal 2021, and connect the second negative input end 2062 of the second device 206 to the second sub-terminal 2022, or may further connect the first negative output end 2052 of the second device 206 to the first sub-terminal 2021, and connect the first negative output end 2052 of the first device 205 to the second sub-terminal 2022. The first sub-terminal 2021 and the second sub-terminal 2022 may be connected inside a module or at the terminal by using a through-current busbar, and are connected to the first negative end 2042 and/or the second negative end 2044 by using a cable (or a copper bar, a connector, or the like).

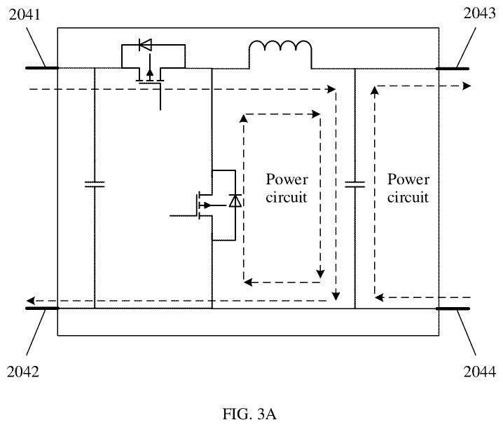

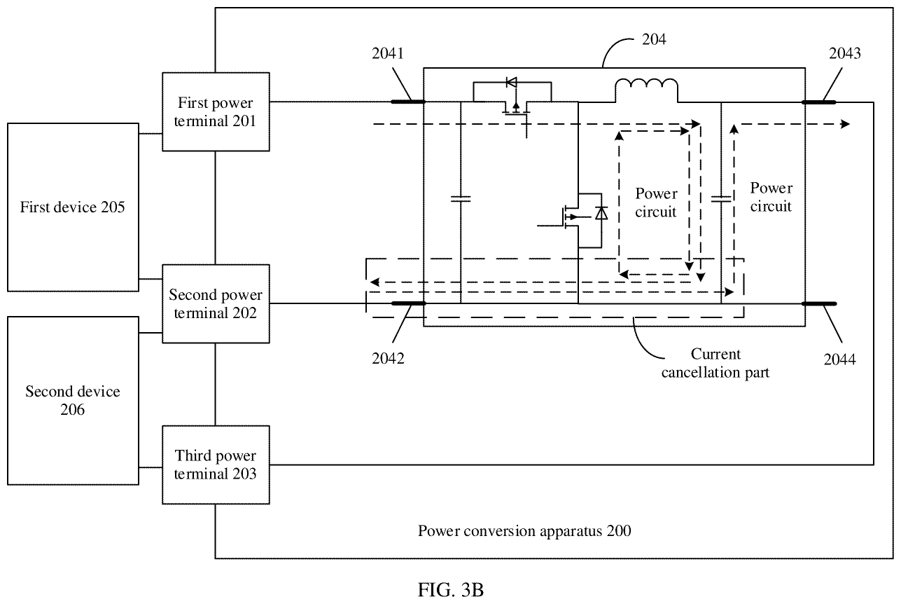

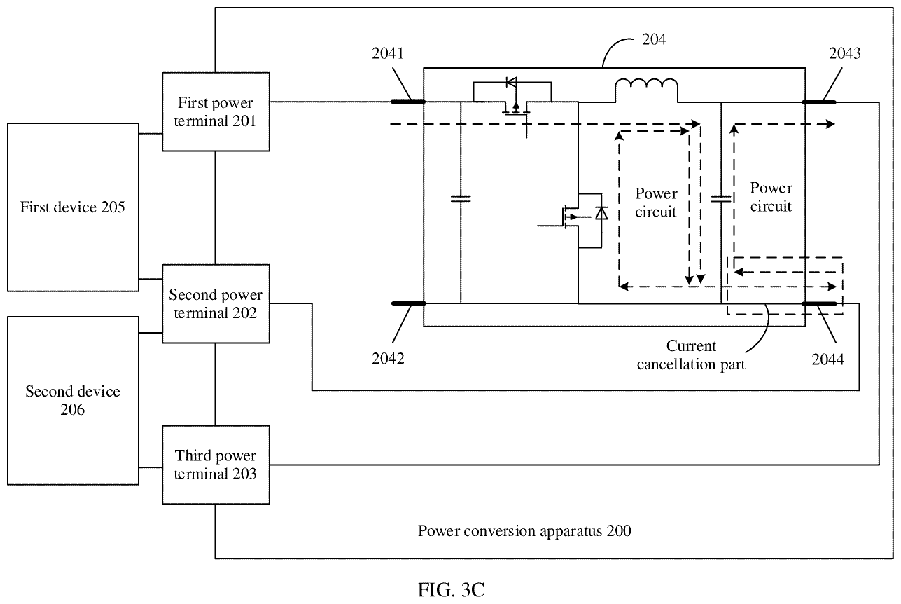

FIG. 3A is a schematic diagram of a current flow direction of an existing power conversion circuit. For example, the power conversion circuit 204 is a buck circuit. A power current input by the first device 205 flows in from the first positive end 2041 and flows out from the first negative end 2042, and a power current output to the second device 206 flows in from the second negative end 2044 and flows out from the second positive end 2043. It may be seen from FIG. 3A that, all positive/negative buses connected to the first positive end 2041, the first negative end 2042, the second positive end 2043, and the second negative end 2044 flow through the power current. Consequently, a PCB heats seriously. In addition, due to a severe heating condition of the PCB, a loss caused by the flowing current is large when the power current flows through the PCB board.

Still using a buck circuit as an example, refer to FIG. 3B. FIG. 3B is a schematic diagram 1 of a current flow direction of the power conversion apparatus. The first device 205 is connected to the first power terminal 201 and the second power terminal 202. A power current input by the first device 205 may flow in from the first positive end 2041 and flow out from the first negative end 2042. The second device 206 is connected to the second power terminal 202 and the third power terminal 203. A power current output to the second device 206 flows in from the first negative end 2042, and flows out from the second positive end 2043.

FIG. 3C is a schematic diagram 2 of a current flow direction of the power conversion apparatus. The first device 205 is connected to the first power terminal 201 and the second power terminal 202. A power current input by the first device 205 may flow in from the first positive end 2041 and flow out from the second negative end 2044. The second device 206 is connected to the second power terminal 202 and the third power terminal 203. A power current output to the second device 206 flows in from the second negative end 2044 and flows out from the second positive end 2043.

Because the second power terminal 202 is connected to the first negative end 2042, the power current input by the first device 205 flows out from the first negative end 2042, and the power current output to the second device 206 flows in from the first negative end 2042. Therefore, the two power currents in opposite directions cancel each other out on the bus connected to the first negative end 2042 (where if two current values are not equal, for a power current with a larger current value, at least a part of the power current is cancelled out by another power current with a smaller current value, so that a current that actually flows through the bus connected to the first negative end 2042 is reduced), which reduces the loss of the PCB caused by the flowing current.

It may be understood from FIG. 3C that, because the second power terminal 202 is connected to the second negative end 2044, the power current input by the first device 205 flows out from the second negative end 2044, and the power current output to the second device 206 flows in from the second negative end 2044. Therefore, the two power currents in opposite directions cancel each other out on the bus connected to the second negative end 2044 (where if two current values are not equal, for a power current with a larger current value, at least a part of the power current is cancelled out by another power current with a smaller current value, so that a current that actually flows through the bus connected to the second negative end 2044 is reduced), which reduces the loss of the PCB caused by the flowing current.

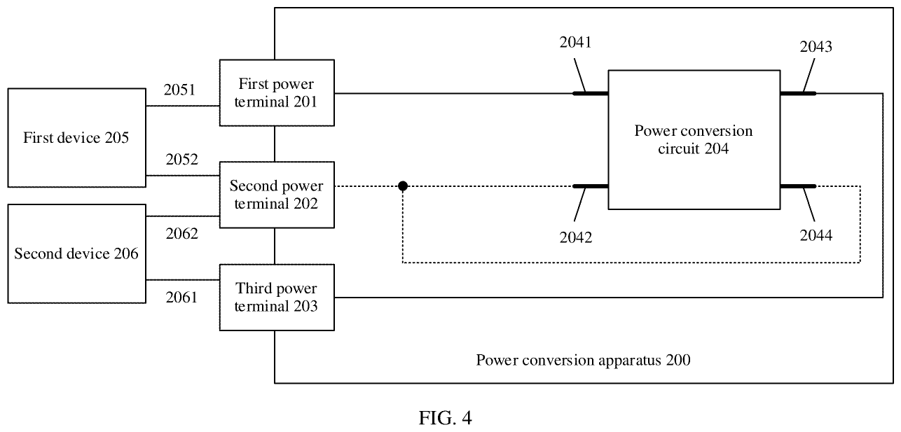

FIG. 4 is a schematic diagram 1 of a connection of the power conversion apparatus. A first positive output end 2051 of the first device 205 is connected to the first power terminal 201, and a first negative output end 2052 of the first device 205 is connected to the second power terminal 202. A second positive input end 2061 of the second device 206 is connected to the third power terminal 203, and a second negative input end 2062 of the second device 206 is connected to the second power terminal 202.

The first device 205 is connected to the first power terminal 201 through the first positive output end 2051, and is connected to the second power terminal 202 through the first negative output end 2052, to input the first voltage to the power conversion circuit 204. The second device 206 is connected to the third power terminal 203 through the second positive input end 2061, and is connected to the second power terminal 202 through the second negative input end 2062, to receive the second voltage output by the power conversion circuit 204. In this topology structure, the first negative output end 2052 and the second negative input end 2062 in the power conversion circuit 204 are used when commonly grounded. On the bus connected to the first negative end 2042 or on the bus connected to the second negative end 2044, the power current flowing out from the first device 205 and the power current flowing into the second device 206 may mutually cancel each other out, which reduces the loss of the PCB caused by the flowing current.

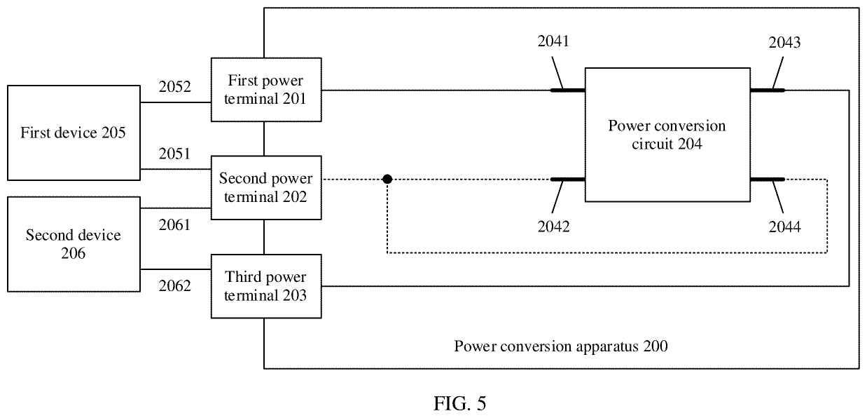

FIG. 5 is a schematic diagram 2 of a connection of the power conversion apparatus. A first positive output end 2051 of the first device 205 is connected to the second power terminal 202, a first negative output end 2052 of the first device 205 is connected to the first power terminal 201, a second positive input end 2061 of the second device 206 is connected to the second power terminal 202, and a second negative input end 2062 of the second device 206 is connected to the third power terminal 203.

The first device 205 is connected to the second power terminal 202 through the first positive output end 2051, and is connected to the first power terminal 201 through the first negative output end 2052, to input the first voltage to the power conversion circuit 204. The second device 206 is connected to the second power terminal 202 through the second positive input end 2061, and is connected to the third power terminal 203 through the second negative input end 2062, to receive the second voltage output by the power conversion circuit 204. In this topology structure, the first positive output end 2051 and the second positive input end 2061 in the power conversion circuit 204 share a power supply. On the bus connected to the second negative end 2044, or on the bus connected to the second negative end 2044, the power current flowing out from the first device 205 and the power current flowing into the second device 206 may mutually cancel each other out, so that the loss of the PCB caused by the flowing current may be reduced.

The foregoing first positive output end 2051 may be a positive terminal of the first device 205, and the first negative output end 2052 may be a negative terminal of the first device 205. The second positive input end 2061 may be used as a positive terminal of the second device 206, and the second negative input end 2062 may be used as a negative terminal of the second device 206.

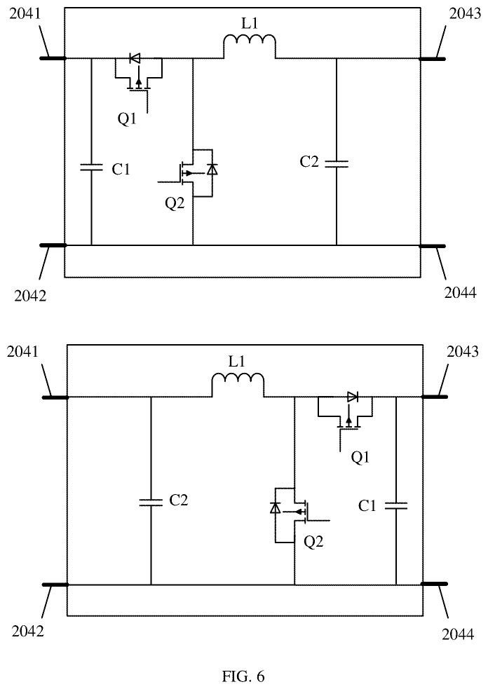

FIG. 6 is a schematic diagram 1 of a structure of the power conversion circuit. The power conversion circuit 204 may include a first capacitor C1, a first switch component Q1, a second switch component Q2, a first inductor L1, and a second capacitor C2, where a first end of the first capacitor C1 is connected to a first end of the first switch component Q1, a second end of the first switch component Q1 is separately connected to a first end of the first inductor L1 and a first end of the second switch component Q2, a third end of the first switch component Q1 is configured to input a signal for controlling a status of the first switch component Q1, a second end of the second switch component Q2 is separately connected to a second end of the first capacitor C1 and a first end of the second capacitor C2, a third end of the second switch component Q2 is configured to input a signal for controlling a status of the second switch component Q2, and a second end of the first inductor L1 is connected to a second end of the second capacitor C2.

The first positive end 2041 is connected to the first end of the first capacitor C1, the first negative end 2042 is connected to the second end of the first capacitor C1, the second positive end 2043 is connected to the first end of the second capacitor C2, and the second negative end 2044 is connected to the second end of the second capacitor C2. Alternatively, the first positive end 2041 is connected to the first end of the second capacitor C2, the first negative end 2042 is connected to the second end of the second capacitor C2, the second positive end 2043 is connected to the first end of the first capacitor C1, and the second negative end 2044 is connected to the second end of the first capacitor C1.

When the power conversion circuit 204 meets a condition of being enabled, turn-off of the power device in the power conversion circuit 204 is controlled to change according to a rule, so that an output voltage of the power conversion circuit 204 may be adjusted. For example, when the first switch component Q1 is enabled, the second switch component Q2 is disabled and the first inductor L1 stores energy. When the first switch component Q1 is disabled, the second switch component Q2 is enabled, and the first inductor L1 releases energy to supply power to the load. Different disabled duty cycles of the first switch component Q1 and the second switch component Q2 are set, to adjust a buck/boost amplitude of the power conversion circuit 204.

To be not limited to a buck mode, a boost mode, or the like, when the first positive end 2041 is connected to the first end of the first capacitor C1 and the first negative end 2042 is connected to the second end of the first capacitor C1, the second positive end 2043 is connected to the first end of the second capacitor C2, and the second negative end 2044 is connected to the second end of the second capacitor C2. In this case, the power conversion circuit 204 is in a buck mode in a forward direction. When the first positive end 2041 is connected to the first end of the second capacitor C2, and the first negative end 2042 is connected to the second end of the second capacitor C2, the second positive end 2043 is connected to the first end of the first capacitor C1, and the second negative end 2044 is connected to the second end of the first capacitor C1. In this case, the power conversion circuit 204 is in a boost mode in a reverse direction.

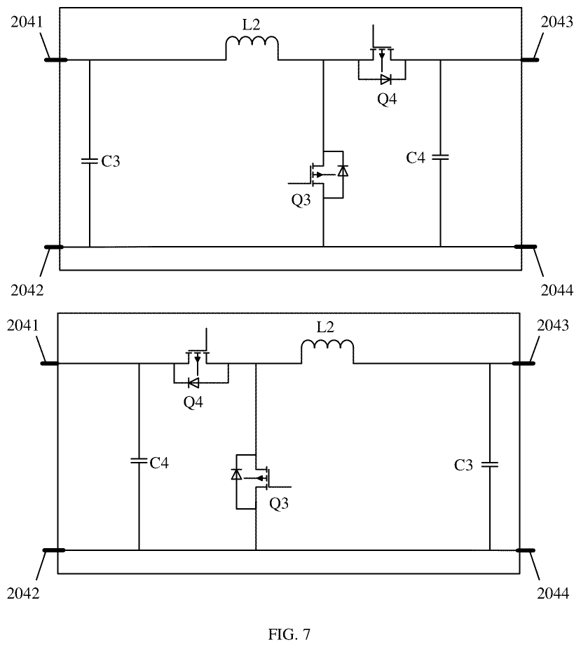

FIG. 7 is a schematic diagram 2 of a structure of a power conversion circuit. The power conversion circuit may include a third capacitor C3, a second inductor L2, a third switch component Q3, a fourth switch component Q4, and a fourth capacitor C4, where a first end of the third capacitor C3 is connected to a first end of the second inductor L2, a second end of the second inductor L2 is separately connected to a first end of the third switch component Q3 and a first end of the fourth switch component Q4, a second end of the third capacitor C3 is separately connected to a second end of the third switch component Q3 and a second end of the fourth capacitor C4, a second end of the fourth switch component Q4 is connected to a first end of the fourth capacitor C4, a third end of the third switch component Q3 is configured to input a signal for controlling a status of the third switch component Q3, and a third end of the fourth switch component Q4 is configured to input a signal for controlling a status of the fourth switch component Q4.

The first positive end 2041 is connected to the first end of the third capacitor C3, the first negative end 2042 is connected to the second end of the third capacitor C3, the second positive end 2043 is connected to the first end of the fourth capacitor C4, and the second negative end 2044 is connected to the second end of the fourth capacitor C4. Alternatively, the first positive end 2041 is connected to the first end of the fourth capacitor C4, the first negative end 2042 is connected to the second end of the fourth capacitor C4, the second positive end 2043 is connected to the first end of the third capacitor C3, and the second negative end 2044 is connected to the second end of the third capacitor C3.

When the power conversion circuit 204 meets a condition of being enabled, turn-off of the power device in the power conversion circuit 204 is controlled to change according to a rule, so that an output voltage of the power conversion circuit 204 may be adjusted. For example, when the third switch component Q3 is enabled, the fourth switch component Q4 is disabled and the second inductor L2 stores energy. When the third switch component Q3 is disabled, the second switch component Q2 is enabled, and the second inductor L2 releases energy to supply power to the load. Different disabled duty cycles of the third switch component Q3 and the fourth switch component Q4 are set, to adjust a buck/boost amplitude of the power conversion circuit 204.

To be not limited to a buck mode, a boost mode, or the like, when the first positive end 2041 is connected to the first end of the third capacitor C3 and the first negative end 2042 is connected to the second end of the third capacitor C3, the second positive end 2043 is connected to the first end of the fourth capacitor C4, and the second negative end 2044 is connected to the second end of the fourth capacitor C4. In this case, the power conversion circuit 204 is in a boost mode in a forward direction. When the first positive end 2041 is connected to the first end of the fourth capacitor C4, and the first negative end 2042 is connected to the second end of the fourth capacitor C4, the second positive end 2043 is connected to the first end of the third capacitor C3, and the second negative end 2044 is connected to the second end of the third capacitor C3. In this case, the power conversion circuit 204 is in a buck mode in a reverse direction.

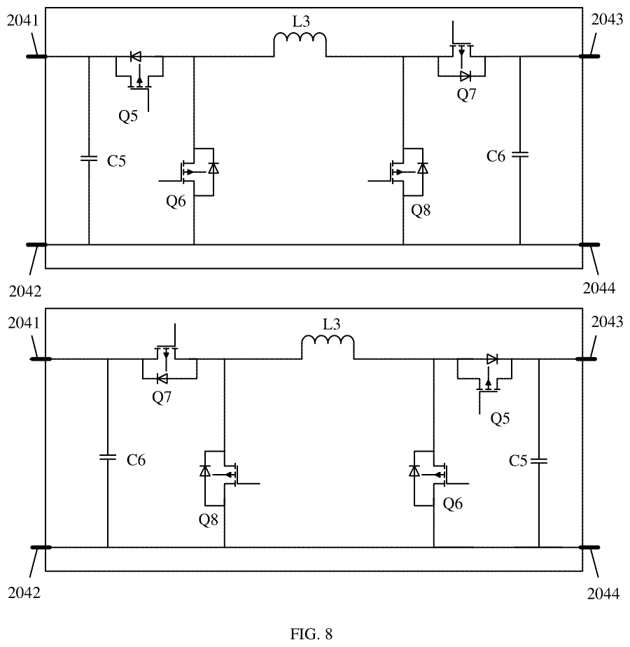

FIG. 8 is a schematic diagram 3 of a structure of a power conversion circuit. The power conversion circuit may include a fifth capacitor C5, a third inductor L3, a fifth switch component Q5, a sixth switch component Q6, a seventh switch component Q7, an eighth switch component Q8, and a sixth capacitor C6, where a first end of the fifth capacitor C5 is connected to a first end of the fifth switch component Q5, a second end of the fifth switch component Q5 is connected to the first end of the third inductor L3, the second end of the fifth switch component Q5 is connected to a first end of the sixth switch component Q6, a second end of the sixth switch component Q6 is connected to a second end of the fifth capacitor C5, a first end of the seventh switch component Q7 is connected to a first end of the sixth capacitor C6, a second end of the seventh switch component Q7 is connected to a first end of the eighth switch component Q8, a second end of the eighth switch component Q8 is connected to the second end of the sixth switch component Q6, the second end of the eighth switch component Q8 is further connected to a second end of the sixth capacitor C6, a second end of the third inductor L3 is connected to the first end of the seventh switch component Q7, a third end of the fifth switch component Q5 is configured to input a signal for controlling a status of the fifth switch component Q5, a third end of the sixth switch component Q6 is configured to input a signal for controlling a status of the sixth switch component Q6, a third end of the seventh switch component Q7 is configured to input a signal for controlling a status of the seventh switch component Q7, and a third end of the eighth switch component Q8 is configured to input a signal for controlling a status of the eighth switch component Q8.

The first positive end 2041 is connected to the first end of the fifth capacitor C5, the first negative end 2042 is connected to the second end of the fifth capacitor C5, the second positive end 2043 is connected to the first end of the sixth capacitor C6, and the second negative end 2044 is connected to the second end of the sixth capacitor C6. Alternatively, the first positive end 2041 is connected to the first end of the sixth capacitor C6, the first negative end 2042 is connected to the second end of the sixth capacitor C6, the second positive end 2043 is connected to the first end of the fifth capacitor C5, and the second negative end 2044 is connected to the second end of the fifth capacitor C5.

When the power conversion circuit 204 meets a condition of being enabled, turn-off of the power device in the power conversion circuit 204 is controlled to change according to a rule, so that an output power of the power conversion circuit 204 may be adjusted. For a manner of adjusting the power device to be disabled, refer to descriptions corresponding to FIG. 6 and FIG. 7. Details are not described herein again.

The first switch component Q1 to the eighth switch component Q8 may be switching transistors or diodes. A person skilled in the art may freely set the first switch component Q1 to the eighth switch component Q8 based on costs and actual conversion efficiency requirements. This is not limited herein.

In a possible embodiment, the power conversion apparatus 200 further includes a controller, configured to control turn on and turn-off of the power device in the power conversion circuit 204, to adjust the output voltage of the power conversion circuit.

The controller may be a general-purpose central processing unit (CPU), a general-purpose processor, a digital signal processor (DSP), an application-specific integrated circuit (ASIC), a field-programmable gate array (FPGA) or another programmable logic device, a transistor logic device, a hardware component, or any combination thereof. The controller may implement or execute various example logical blocks, modules, and circuits described with reference to content in the embodiments.

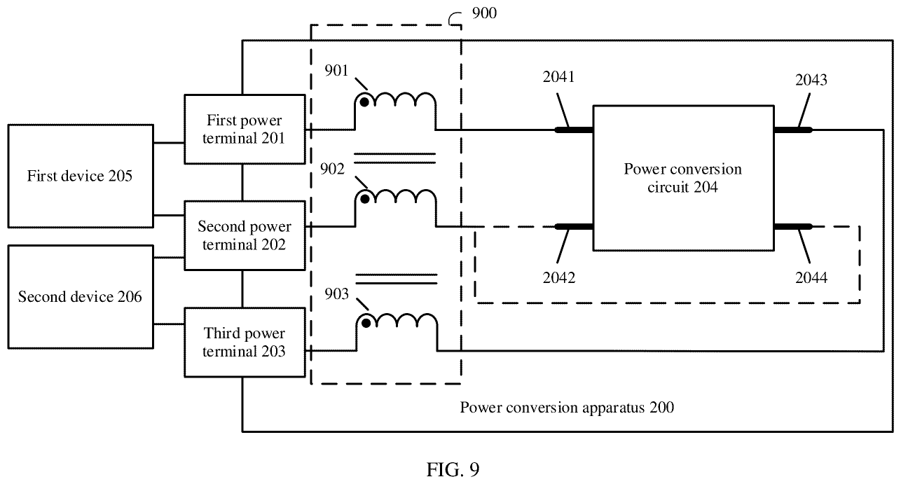

To suppress common-mode noise of the power conversion circuit 204, FIG. 9 is a schematic diagram 3 of a structure of a power conversion apparatus. The power conversion apparatus 200 further includes a three-wire common-mode inductor 900. The three-wire common-mode inductor 900 includes a first winding 901, a second winding 902, and a third winding 903, a dotted terminal of the first winding 901 is connected to a first power terminal 201, a dotted terminal of the second winding 902 is connected to a second power terminal 202, and a dotted terminal of the third winding 903 is connected to a third power terminal 203. An unnamed end of the first winding 901 is connected to the first positive end 2041, the first negative end 2042 and/or the second negative end 2044 is connected to the unnamed end of the second winding 902, and an unnamed end of the third winding 903 is connected to the second positive end 2043.

The three-wire common-mode inductor 900 is configured to suppress the common-mode noise in the power conversion circuit 204. After the common-mode noise at the first negative end 2042 or the second negative end 2044 is suppressed, only a ripple current flows through the second winding 902 connected to the first negative end 2042 or the second negative end 2044, which reduces a coil loss.

In a possible embodiment, the second power terminal may be a copper bar or a connector structure. The first negative output end 2052 of the first device 205 and the second negative input end 2062 of the second device 206 may be connected to the first negative end 2042 or the second negative end 2044 by using a cable copper bar or a connector structure. Alternatively, the first positive output end 2051 of the first device 205 and the second positive input end 2061 of the second device 206 may be connected to the first positive end 2041 or the second positive end 2043 by using a copper bar or a connector structure.

In a possible embodiment, at least one of the following devices may be included between the first power terminal 201 and the second power terminal 202: a fuse, a switch component, or a shunt. The fuse may be blown immediately when a current in a loop increases rapidly because of a short-circuit fault of a line, so as to protect an electrical device and a line connected to the fuse, thereby avoiding an accident caused by damage. The switch component is configured to control a connection status between the first power terminal 201 and the second power terminal 202. The shunt is configured to measure a magnitude of a current between the first power terminal and the second power terminal, and is made according to a principle a voltage is generated at two ends of a resistor when the current passes through the resistor.

In this embodiment, the first power terminal 201 and the third power terminal 203 may also be a copper bar or a connector structure. This is not limited herein. The terminals in the foregoing embodiments are defined based on functions. If a plurality of terminals are connected in parallel due to a reason such as the flowing current, terminals with a same function may be considered as a same terminal.

According to the power conversion apparatus, a three-power terminal structure is used, so that power currents flowing through a bus connected to a first negative end or a second negative end may mutually cancel each other out, which reduces a loss on a PCB board caused by the flowing current. In addition, after common-mode noise is filtered by using a common-mode inductor, a current that flows through the common-mode inductor connected to the first negative end or the second negative end may be a ripple current, which reduces a coil loss.

Based on a same idea, the embodiments may provide an energy storage system, including a battery pack and the power conversion apparatus described in the foregoing embodiment. The battery pack includes a plurality of battery cells connected in series, and the power conversion apparatus is connected to the battery pack, configured to convert a direct current input to the battery pack, and/or convert a direct current output from the battery pack. Optionally, the battery pack includes a plurality of battery strings in parallel, and each battery string includes a plurality of battery cells connected in series.

Based on a same concept, the embodiments may further provide an optical storage system, including an inverter, the power conversion apparatus, and the battery pack described in the foregoing embodiments. The power conversion apparatus is configured to convert a current from the inverter, and input the converted current to the battery pack, and/or is configured to convert a current of the battery pack, and output the converted current to a power grid or a load. Optionally, the battery pack includes a plurality of battery strings in parallel, and each battery string includes a plurality of battery cells connected in series.

A person skilled in the art should understand that the embodiments may be provided as a method, a system, or a computer program product. Therefore, the embodiments may use a form of hardware-only embodiments, software-only embodiments, or embodiments with a combination of software and hardware. In addition, the embodiments may use a form of a computer program product implemented on one or more computer-usable storage media (including, but not limited to, a disk memory, a CD-ROM, an optical memory, or the like) that include computer-usable program code.

The embodiments may be described with reference to flowcharts and/or block diagrams of the method, a device (system), and a computer program product. It should be understood that each procedure and/or block in the flowcharts and/or block diagrams, and combinations of the procedures and/or blocks in the flowcharts and/or block diagrams may be implemented by computer program instructions. These computer program instructions may be provided for a general-purpose computer, a dedicated computer, an embedded processor, or a processor of any other programmable data processing device to generate a machine, so that the instructions executed by the computer or the processor of any other programmable data processing device generate an apparatus for implementing a function in one or more processes in the flowcharts and/or in one or more blocks in the block diagrams.

These computer program instructions may be stored in a non-transitory computer-readable memory that may instruct the computer or any other programmable data processing device to work in a manner, so that the instructions stored in the computer-readable memory generate an artifact that includes an instruction apparatus. The instruction apparatus implements a function in one or more processes in the flowcharts and/or in one or more blocks in the block diagrams.

The computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a function in one or more procedures in the flowcharts and/or in one or more blocks in the block diagrams.

It is clear that a person skilled in the art may make various modifications and variations without departing from the scope of the embodiments and their equivalents.

1. A power conversion apparatus, comprising:
a power conversion circuit, wherein the power conversion circuit comprises a first positive end, a first negative end, a second positive end, a second negative end, and at least one power device, and the first negative end and the second negative end have a same potential;
a first power terminal;
a second power terminal;
a third power terminal;
a three-wire common-mode inductor, wherein the three-wire common-mode inductor comprises a first winding, a second winding, and a third winding, a dotted terminal of the first winding is connected to the first power terminal, a dotted terminal of the second winding is connected to the second power terminal, and a dotted terminal of the third winding is connected to the third power terminal; and
an undotted terminal of the first winding is connected to the first positive end, the first negative end or the second negative end is connected to an undotted terminal of the second winding, and an undotted terminal of the third winding is connected to the second positive end, wherein
the first negative end or the second negative end is connected to the second power terminal, and the third power terminal is connected to the second positive end.

2. The power conversion apparatus according to claim 1, wherein
a first positive output end of a first device is connected to the first power terminal, and a first negative output end of the first device is connected to the second power terminal;
a second positive input end of a second device is connected to the third power terminal, and a second negative input end of the second device is connected to the second power terminal;
the first device is an energy storage unit, and the second device is a load device or a power grid;
the second power terminal further comprises:
a first sub-terminal connected to a first negative output end of the first device; and
a second sub-terminal connected to a second negative input end of the second device.

3. The power conversion apparatus according to claim 2, wherein a first positive output end of the first device is connected to the first power terminal, and a first negative output end of the first device is connected to the second power terminal; and
a second positive input end of the second device is connected to the third power terminal, and a second negative input end of the second device is connected to the second power terminal.

4. The power conversion apparatus according to claim 2, wherein a first positive output end of the first device is connected to the second power terminal, and a first negative output end of the first device is connected to the first power terminal; and
a second positive input end of the second device is connected to the second power terminal, and a second negative input end of the second device is connected to the third power terminal.

5. The power conversion apparatus according to claim 2, wherein the power conversion circuit further comprises:
a first capacitor;
a first switch component;
a second switch component;
a first inductor; and
a second capacitor, wherein a first end of the first capacitor is connected to a first end of the first switch component, a second end of the first switch component is separately connected to a first end of the first inductor and a first end of the second switch component, a third end of the first switch component is configured to input a signal for controlling a status of the first switch component, a second end of the second switch component is separately connected to a second end of the first capacitor and a first end of the second capacitor, a third end of the second switch component is configured to input a signal for controlling a status of the second switch component, and a second end of the first inductor is connected to a second end of the second capacitor; and
the first positive end is connected to the first end of the first capacitor, the first negative end is connected to the second end of the first capacitor, the second positive end is connected to the first end of the second capacitor, and the second negative end is connected to the second end of the second capacitor; or the first positive end is connected to the first end of the second capacitor, the first negative end is connected to the second end of the second capacitor, the second positive end is connected to the first end of the first capacitor, and the second negative end is connected to the second end of the first capacitor.

6. The power conversion apparatus according to claim 5, wherein the power conversion circuit further comprises:
a third capacitor;
a second inductor;
a third switch component;
a fourth switch component; and
a fourth capacitor, wherein a first end of the third capacitor is connected to a first end of the second inductor, a second end of the second inductor is separately connected to a first end of the third switch component and a first end of the fourth switch component, a second end of the third capacitor is separately connected to a second end of the third switch component and a second end of the fourth capacitor, a second end of the fourth switch component is connected to a first end of the fourth capacitor, a third end of the third switch component is configured to input a signal for controlling a status of the third switch component, and a third end of the fourth switch component is configured to input a signal for controlling a status of the fourth switch component; and
the first positive end is connected to the first end of the third capacitor, the first negative end is connected to the second end of the third capacitor, the second positive end is connected to the first end of the fourth capacitor, and the second negative end is connected to the second end of the fourth capacitor; or the first positive end is connected to the first end of the fourth capacitor, the first negative end is connected to the second end of the fourth capacitor, the second positive end is connected to the first end of the third capacitor, and the second negative end is connected to the second end of the third capacitor.

7. The power conversion apparatus according to claim 6, wherein the power conversion circuit further comprises:
a fifth capacitor;
a third inductor;
a fifth switch component;
a sixth switch component;
a seventh switch component;
an eighth switch component; and
a sixth capacitor, wherein a first end of the fifth capacitor is connected to a first end of the fifth switch component, a second end of the fifth switch component is connected to the first end of the third inductor, the second end of the fifth switch component is connected to a first end of the sixth switch component, a second end of the sixth switch component is connected to a second end of the fifth capacitor, a first end of the seventh switch component is connected to a first end of the sixth capacitor, a second end of the seventh switch component is connected to a first end of the eighth switch component, a second end of the eighth switch component is connected to the second end of the sixth switch component, the second end of the eighth switch component is further connected to a second end of the sixth capacitor, a second end of the third inductor is connected to the first end of the seventh switch component, a third end of the fifth switch component is configured to input a signal for controlling a status of the fifth switch component, a third end of the sixth switch component is configured to input a signal for controlling a status of the sixth switch component, a third end of the seventh switch component is configured to input a signal for controlling a status of the seventh switch component, and a third end of the eighth switch component is configured to input a signal for controlling a status of the eighth switch component; and
the first positive end is connected to the first end of the fifth capacitor, the first negative end is connected to the second end of the fifth capacitor, the second positive end is connected to the first end of the sixth capacitor, and the second negative end is connected to the second end of the sixth capacitor; or the first positive end is connected to the first end of the sixth capacitor, the first negative end is connected to the second end of the sixth capacitor, the second positive end is connected to the first end of the fifth capacitor, and the second negative end is connected to the second end of the fifth capacitor.

8. The power conversion apparatus according to claim 1, further comprising a controller configured to:
control turn-on and turn-off of the power device in the power conversion circuit, and
adjust an output voltage of the power conversion circuit.
